(19) United States
(12) Patent Application Publication
(10) Pub. No.: US 2016/0066599 A1
(43) Pub. Date: Mar. 10, 2016

(54) FEED MIX FOR BIRDS

(71) Applicant: Canadian Wildlife Federation Inc./Fédération Canadienne de la Faune Inc., Kanata (CA)

(72) Inventors: Deborah A. MCWILLIAMS, Guelph (CA); Frederick BATES, Kanata (CA)

(73) Assignee: Canadian Wildlife Federation Inc./Fédération Canadienne de la Faune Inc., Kanata (CA)

(21) Appl. No.: 14/844,403

(22) Filed: Sep. 3, 2015

Related U.S. Application Data
(60) Provisional application No. 62/045,243, filed on Sep. 3, 2014.

(51) Int. Cl. A23K 1/14; A23K 1/18

(52) U.S. Cl. CPC A23K 1/14; A23K 1/182

(57) ABSTRACT

A feed mix for birds, comprising at least one of seeds, nuts and berries, the mix having: an aggregate protein content in the range of 14% to 30% by dry weight; an aggregate fat content in the range of 15% to 51% by dry weight; an aggregate content of palmitic acid in the range of 1% to 30% by dry weight; an aggregate content of stearic acid in the range of 1.0% to 26% by dry weight; an aggregate content of oleic acid in the range of 9% to 62% by dry weight; an aggregate content of linoleic acid in the range of 1.5%-81.5% by dry weight; and an aggregate content of linolenic acid in the range of 0.05% to 17% by dry weight.

This application claims priority based on U.S. Patent Application No. 62/045,243 entitled “FEED MIX FOR BIRDS” filed Sep. 3, 2014, which is herein incorporated by reference.

### FIELD OF INVENTION

The invention relates to feed for animals. In particular, the invention relates to mixtures of seeds, nuts and berries for consumption by wild birds.

### BACKGROUND

Currently, there are many different feed mixes available for feeding wild birds. These mixes vary from one another in terms of their content (i.e., seeds, nuts, berries, etc.) and the proportions in which these contents are present. Most feed mixes are intended for use to attract a particular species of bird, or to attract species that are indigenous to a particular geographic area. The contents of the feed mixes, and the proportions in which the contents are present, are selected from seeds, nuts, berries, etc. that are either known or believed to be preferred by the species the mix is intended to attract.

There are several disadvantages to current bird feed mixes of the kind described above. Since many such mixes are tailored to a particular species, the mix has limited usefulness for attracting and feeding any birds other than the intended species. People who feed birds must therefore keep many different kinds of feed depending on the types of birds they would like to attract, and manufacturers must make and support numerous different blends to meet market demand. As well, such feed mixes do not necessarily meet all nutritional requirements of the birds that eat it, whether it is the intended species for the feed mix or otherwise. Furthermore, such mixes often contain filler ingredients, such as milo, millet, and cereal grains such as corn, oats and wheat. Such filler ingredients are often left behind by birds, and either end up as waste or attract unwanted animals such as squirrels.

### SUMMARY OF THE INVENTION

It has been discovered that the dietary preferences of wild birds do not vary across species or geographic areas as much as was once thought. The dietary preferences of birds do appear to vary based on the size of the bird, however. Wild birds tend to eat seeds, nuts, berries, etc., that correspond to their body size; i.e., small birds eat small seeds, nuts and berries, whereas larger birds eat larger seeds, nuts and berries. As well, wild birds tend to prefer foods that provide the nutrients needed for particular life events such as migrations (occurring in the fall and the spring), winter survival (for birds that do not migrate south in the winter) and breeding.

Using the foregoing discoveries, it is possible to formulate a feed mix for wild birds that appeals to a wide variety of species of birds and can be used across a wide geographic area. In one embodiment of the invention, such a feed mix comprises at least one of seeds, nuts and berries, and has an aggregate protein content in the range of 14% to 30% by dry weight, an aggregate fat content in the range of 15% to 51% by dry weight, an aggregate content of palmitic acid in the range of 1% to 30% by dry weight, an aggregate content of stearic acid in the range of 1.0% to 26% by dry weight, an aggregate content of oleic acid in the range of 9% to 62% by dry weight, an aggregate content of linoleic acid in the range of 1.5%-81.5% by dry weight, and an aggregate content of linolenic acid in the range of 0.05% to 17% by dry weight.

In another embodiment of the invention, there is provided a feed mix for birds comprising at least one of seeds, nuts and berries, and having an aggregate protein content in the range of 15% to 24% by dry weight, an aggregate fat content in the range of 15% to 29% by dry weight, an aggregate content of palmitic acid in the range of 1% to 30% by dry weight, an aggregate content of stearic acid in the range of 1.5% to 26% by dry weight, an aggregate content of oleic acid in the range of 9% to 62% by dry weight, an aggregate content of linoleic acid in the range of 1.5%-81.5% by dry weight, and an aggregate content of linolenic acid in the range of 1% to 17% by dry weight.

### DESCRIPTION OF EMBODIMENTS OF THE INVENTION

Particular embodiments of the feed mix of the present invention will now be described. The described embodiments of the inventive feed mix are derived based on the following observations regarding the diets and feeding habits of wild birds that are indigenous to Canada. However, it will be understood that other embodiments of the inventive feed mix are possible, and can be derived by adapting the observations set out below to other geographic areas.

### The Composition of Wild Bird Feed Need not be Selected Based on Geographic Area.

In general, most seed-eating bird species in Canada are omnivores and opportunistically eat foods (plants and animal matter) that are available across Canada depending on season. The variety and abundance of some plant subspecies (e.g., seeds and nuts) may vary between geographic areas, but in general, the seed-eating bird species eat very similar diets in all geographic areas.

In addition to literature support for this premise, current bird seed formula products available for purchase also support the premise. For example, Table 1 describes the various seed and nut blend products made by Scott's™ Miracle Grow™ specialty blends. The bird seed and nuts products offered by Scott's™ are premium, and offer some variety of ingredients. However, the Scott's™ products are very similar despite the fact that they are named after (and presumably, intended for use in) different geographic areas and/or types of birds. The products are based on sunflower (black oil and striped), niger, peanuts, millet and safflower. The Scott's™ products are named after various geographic locations like “Northeastern Bird Blend” and “Southwestern Bird Blend”, but the mixes are based on a few base ingredients and some other ingredients are added or eliminated.

TABLE 1
Comparison of Scott's Wild Bird Seed Blend Products

| | | | Millet | | | | | | | | | | | |
|---|---|---|---|---|---|---|---|---|---|---|---|---|---|---|
| | Black | | (white | | | Sun- | | | Pump- | | | Cherries | | Almond |
| Scott's | oil sun- | | And/or | Saf- | | flower | | Canary | kin | Juniper | | Or | Blue- | Or |
| Blend | flower | Niger | red) | flower | Peanuts | (striped) | Canola | Seed | seeds | berries | Raisins | papaya | berries | Pecan |
| North- | X | x | x | x | x | X | | | x | | x | x | | |
| eastern | | | | | | | | | | | | | | |
| Bird Blend | | | | | | | | | | | | | | |
| Midwestern | X | x | x | x | x | X | X | | | | x | x | | |
| Bird Blend | | | | | | | | | | | | | | |
| South- | X | x | x | x | x | X | | | x | | x | | x | |
| eastern | | | | | | | | | | | | | | |
| Bird Blend | | | | | | | | | | | | | | |
| South- | X | x | xx | x | x | X | | | | | x | | | x |
| western | | | | | | | | | | | | | | |
| Bird Blend | | | | | | | | | | | | | | |
| Western | X | x | xx | | x | X | | | | | x | | | x |
| Bird Blend | | | | | | | | | | | | | | |
| Cardinal | X | | x | x | | | | | | | | x | | |
| Blend | | | | | | | | | | | | | | |
| Finch Blend | | x | x | | | X | | | | | | | | |
| Finch/Small | | x | x | | | X | | | | | | | | |
| Songbird | | | | | | | | | | | | | | |
| Blend | | | | | | | | | | | | | | |
| Colorful | X | x | x | x | x | X | | | | X | x | | | |
| Bird Blend | | | | | | | | | | | | | | |
| Multi-bird | x | | x | x | x | X | | | | | | | | |
| Blend | | | | | | | | | | | | | | |
| Multi-bird | x | | xx | x | x | X | | | | | x | x | | x |
| Blend + | | | | | | | | | | | | | | |
| Fruit/nuts | | | | | | | | | | | | | | |
| No mess | | | xx | | x | X | | X | | | | | | |
| Patio blend | | | | | | | | | | | | | | |

The Scott's™ products also include ingredients that are intended to be eaten by wild birds in a geographic area, although one might question whether birds in the intended geographic area actually will eat some of the contents of the blend. For example, only the Northeastern and Midwestern Bird Blends include cherries or papaya implying that only seed-eating bird species in these areas would eat cherries and papaya. Cherries (wild and cultivated) grow in several Canadian provinces and in many U.S. states, and are eaten by many bird species if available. Papaya is grown in the United States, but only in southern state areas (California, Texas, Florida) and in Hawaii—not in the northeast or midwest United States as the Scott's northeastern or Midwestern bird blends imply. It is likely that fruits are included in wild bird seed mixes for their colour and carotenes. Dietary carotenes support immune function and integument colour in bird species, even in those species without bright colours (see Metzger B J & Bairlein F. 2011. Fat stores in a migratory bird: a reservoir of carotenoid pigments for times of need? Journal of Comparative Physiology B, 181: 269-275.). Seeds and nuts have carotenes, but the inclusion of colourful fruit would provide a higher level of, and a wider spectrum of carotenes.

In view of the foregoing, it appears that wild bird feed blends need not be formulated based on the geographic area in which they are intended to be used.

### The Composition of Wild Bird Feed Need not be Selected on the Basis of Species.

As is the case with bird species indigenous to different geographic areas, omnivorous species that are indigenous to the same geographic area eat very similar diets on a seasonal basis. In addition to literature that supports this premise, the product formulation of wild bird seed mix reveal very similar seed mixes despite formulation for various bird species. To illustrate, Table 2A describes some products from Chin Ridge Seeds™ that are designed for specific bird species. In general, the mixes tend to rely upon niger, millet and sunflower (black oil and/or striped) and then vary by the addition or exclusion of various other seed and nuts. Table 2B describes the recommendations found on the website of Wild Birds Unlimited (http://www.wbu.com/education) for feeding by bird species. In general, their information says the most popular seeds eaten by most seed-eating bird species are sunflower (black oil and striped), safflower and niger.

TABLE 2A
Comparison of Some Chin Ridge Wild Bird Seed Formulations

| | | | Millet | | | | Canary | | | Almond, |
|---|---|---|---|---|---|---|---|---|---|---|
| | Black oil | | (proso, white | | Sunflower | | grass | Cereal | | walnut |
| Chin Ridge | sunflower | Niger | And/or red) | Peanuts | (striped) | Canola | Seed | grains* | Corn | Or pecan |
| Chickadee | x | | | | X | | | | | xxx |
| Nuthatch | | | | | | | | | | |
| Jay/ | | | | x | X | | | | x | |
| woodpecker | | | | | | | | | | |
| Mountain | x | | x | | X | | | X | x | |
| bird¹ | | | | | | | | | | |
| No mess | | | x | | X | | | | | xxx |
| Gardener | | | | | | | | | | |
| Songbird² | x | | xx | | X | x | x | | x | |
| Wild bird | x | | xxx | | X | | x | | | |
| Premium | | | | | | | | | | |
| Wild Finch | | x | x | | X | x | x | | | |

*Grains were not specified
¹This mix is mostly corn
²This mix is mostly canary grass seed and millet.

TABLE 2B
Comparison of the Wild Birds Unlimited Recommendations
for Feeding Wild, Seed-eating Birds

| | | | | | | Millet |
|---|---|---|---|---|---|---|
| | Black | | Sun- | | | (proso, |
| | oil Sun- | Saf- | flower | | | white and/ |
| Chin Ridge | flower | flower | (striped) | Niger | Peanuts | or red) |
| Cardinal | X | x | | | | |
| Chickadee | X | x | | | | |
| Grosbeak | X | x | | | | |
| Pine siskin | X | x | X | X | | |
| Redpoll | X | x | X | X | | |
| Finch | X | x | X | X | | |
| Junco's | X | x | X | X | | |
| Bunting | X | x | X | X | | |
| Blue Jay | | | X | | x | |
| Nuthatch | X | | | | x | |
| Woodpecker | | | | | x | |
| Sparrow | | | | | | X |

The seeds and nuts most reported as preferred by wild, seed-eating bird species include sunflower (black oil and striped), niger, peanuts and safflower. However, with the exception of millet, most wild bird species will eat any of these foods although smaller birds would tend to select smaller seeds and nuts (or pieces). Some smaller bird species (e.g., sparrows) that are reported to prefer millet may actually only have millet to eat because larger birds are more aggressive and eat the most palatable foods and leave the least palatable (millet).

Therefore, it appears to be unnecessary to formulate wild bird feed on the basis of the species of bird for which it is intended.

The Composition of Wild Bird Feed should be Selected on the Basis of the Size of Bird for which it is Intended.

Wild birds will tend to feed on seeds and nuts that are appropriate to their size, although there is some speciated and phenotypic flexibility in the wild feeding ecology that allows variance. The inventors have found that different formulations of bird feed should be offered to bird species falling into the following categories:
Small, seed-eating bird species having mass lower than 60 g;
Medium, seed-eating bird species having mass greater than 50 g, but lower than 100 g; and
Large, seed-eating bird species having mass greater than 100 g.

In addition to formulating feed mixes to accommodate bird size, the user of feed mixes should be aware that the feeder design can limit or hinder wild birds depending on their body size. For example, smaller bird species may avoid feeders that can be accessed by larger, aggressive bird species (see Cimprich D A & Grubb J T C Jr. 1994. Consequences for Carolina chickadees of foraging with tufted titmice in winter. Ecology, 75: 1615-1625.) or they may only have access to left-over feed and/or less palatable feed after larger bird species have fed. Using feeders appropriate to a bird size would allow smaller species to feed on appropriate feed mixes and have an opportunity to successfully compete for food with only bird species of their size.

The Composition of Wild Bird Feed should be Selected on the Basis of Wild Feeding Ecology.

In general, wild bird feed should be formulated by selecting those seeds and nuts (and other components, if appropriate) most popular with wild bird species that provide nutrients based on wild feeding ecology and bird physiology to support migration (fall and spring), winter survival and breeding. The preferential eating of wild, seed-eating birds is very similar for all of these life events and the formulas should represent this as closely as possible.

In all areas of Canada for example, migrant and wintering bird species that eat seeds and nuts have diets very similar in form and function although the actual plant or tree species may vary. Migrating wild seed-eating bird species and those species that winter in Canada preferentially seek and eat seeds and nuts higher in fat as compared to the dietary fat of spring migration and breeding (see Table 3), but the range of dietary protein and fat is very similar for all life events. For example, spring migration and breeding diets are not low in fat and some dietary fat is obtained by eating seeds and nuts. However, most seed-eating species will begin to preferentially eat insects as they become available in early spring and these insects provide dietary fat and a variety of fatty acids. Examples of the fat content of some insect prey are fly larvae (20.0%-29.4% by dry weight), cockroach (28.4% by dry weight), earthworm (17.7% by dry weight), corn borer larvae (17.2% by dry weight) and cricket (13.8% by dry weight) (see Bernard J B, Allen M E & Ullrey D E. 1997. Feeding captive insectivorous animals: nutritional aspects of insects as food. www.nagonline.net/Technical %20papers.).

TABLE 3
Ranges of protein and fat (dry matter, DM) in wild seed and nuts
commonly available to wild bird species in Canada in fall/winter and
spring/summer divided into categories of nuts, various seeds and
flowering plant seeds.

| | | |
|---|---|---|
| Nut/Seed Category | Protein (%) | Fat (%) |

Fall/Winter

| | | |
|---|---|---|
| Nuts | 15.2-17.1 | 28.7-31.0 |
| Various Seeds | 19.6-21.0 | 17.3-18.3 |
| Flowering | 20.0-23.7 | 15.5-26.2 |
| Average: | 18.2-20.6 | 20.5-25.3 |

Spring/Summer

| | | |
|---|---|---|
| Grasses | 9.7-15.8 | 4.0-5.2 |
| Various Seeds | 15.5-21.9 | 3.4-5.8 |
| Flowering | 20.0-27.1 | 10.1-17.5 |
| Average: | 15.1-21.6 | 5.8-9.5 |

Although migrating birds have lower dietary protein requirements as compared to non-migratory birds (see Langlois L A & McWilliams S R. 2010. Protein requirements of an omnivorous and a granivorous songbird decrease during migration. The Auk, 127(4): 850-862.), seeds and nuts provide high levels of both protein and fat to meet the dietary and energy needs of seed-eating bird species that migrate and species that winter. The high fat content of seeds and nuts also provide fat (energy) and protein for moulting and replacing feathers. Birds in molt need at least a 17% increase in dietary energy (Bonier et al, 2007) provided mostly by dietary fat, but this increased energy is in addition to that needed for fat stores.

The seeds and nuts most preferred by wild birds are sunflower (black oil (38.5% fat), striped sunflower (47.9% fat)) and niger seeds (35.4% fat) (see Horn D T et al. 2013. Bird abundance at feeders increases with decreasing distance to cover. Transactions of the Illinois State Academy of Science, 96(4): 247-254.). Table 4 describes the averages or range for high fat, common, nuts and seeds fed to wild birds. The most common seeds reported as not attractive to wild birds are millet, sorghum, flax, canola, canary seed, wheat and, oats.

TABLE 4
The protein and fat averages or range for high fat, common nuts
and seeds fed to wild birds.

| Ingredient | Protein (%) | Fat (%) |
|---|---|---|
| Canola, full-fat | 19.0-21.0 | 47.0-50.0 |
| Flax seed | 18.0-23.8 | 36.6-42.0 |
| Niger (nyger) | 22.3 | 35.4 |
| seed | | |
| Sesame seed | 20.5 | 50.0-60.0 |
| (white, red) | | |
| Sesame seed | 20.5 | 60.0 |
| (black) | | |
| Peanuts, whole or | 26.0 | 49.3 |
| pieces | | |
| Safflower, hulled, | 16.2 | 38.5 |
| whole or pieces | | |
| Sunflowers, black | 16.1 | 38.5 |
| oil, whole with | | |
| shell | | |
| Sunflower, | 16.6 | 47.9 |
| striped, hulled, | | |
| whole or pieces | | |

In addition to ingesting high fat seeds and nuts, wild seed-eating bird species select for a very specific range of fatty acids. Wild birds prefer diets high in unsaturated fat especially C18 fatty acids (e.g., oleic, linoleic and alpha-linolenic) and can directly deposit these dietary fatty acids into fat stores (see Bairlein F. 2003. Nutritional strategies in migratory birds. In: P. Berthold, E. Gwinner & E. Sonnenschein (Eds.), Avian Migration. Springer-Verlag Heidelberg, New York, U.S.A., 610 pp., pp. 321-332; see also McWilliams S R et al. 2004. Flying, fasting and feeding in birds during migration: a nutritional and physiological ecology perspective. Journal of Avian Biology, 35: 377-393.). Preference for these fatty acids is similar in all migrating species regardless of nutritional niche (granivores, frugivore, omnivore, etc.). Tables 5 and 6 describe these fatty acids and where they are found in seeds and nuts commonly used in wild bird seed mixes. Note that fruits are very low in protein and fat, therefore also low in fatty acids.

TABLE 5
Ranges and averages of relevant fatty acids in seeds preferred by
wild birds.

| Seed/Nut | 16:0 (palmitic | 18:0 (stearic | 18:1 (oleic | 18:2 (linoleic | 18:3 |
|---|---|---|---|---|---|
| (hulled) | acid) | acid) | acid) | acid) | (linolenic acid) |
| Canola | 3.5%⁸ | 1.5%⁸ | 60.1%⁸ | 20.1%⁸ | 9.6%⁸ |
| Flax | 4.6-6.3%³ | 3.3-6.1%³ | 19.3-29.4³ | 14.0-18.2%³ | 44.6-51.5%³ |
| Niger (nyger) | 17.0%², | 7.0%², | 11.0%², | 63.0%², | 3.0%² |
| | 5.0-8.4%⁴ | 2.0-4.9%⁴ | 31.1-38.9⁴ | 51.6-54.3%⁴ | |
| Peanut | 8.7-13.0%^{5,9} | 3.8-4.5%⁵ | 43.1-55.1%^{5,9} | 25.1-35.2%^{5,9} | 0.2-0.3%⁵ |
| | | 5.2-6.3%⁹ | | | |
| Safflower | 4.1-7.9%¹, | 1.1-4.6%¹, | 15.6-81.4%¹, | 7.2-17.3%¹, | 0.1-1.2%¹, |
| | 5.6-6.9%⁶ | 1.9-2.2%⁶ | 10.0-32.1%⁶ | 54.2-81.5%⁶ | 0.10%⁶ |
| Sunflower | 6.5%⁷ | 1.98%⁷ | 45.4%⁷ | 46.02%⁷ | 0.12%⁷ |
| | 7.0-7.1%⁹ | 4.8-6.6%⁹ | 20.1-22.6⁹ | 62.7-64.3%⁹ | |

¹Burban A. 2007. The determination of oil content and fatty acid composition of domestic and exotic safflower (Carthamus tinctoriius L.) genotypes and their interactions. Journal of Agronomy, 6: 415-420.
²Ramadan MF & Mörsel JT. 2003. Determination of lipid classes and fatty acid profile of niger (Guizotico abyssinica cass.) seed oil. Phytochemical Analysis, 14(6): 366-370.
³Berglund, 2002
⁴Duke, JA. 1983. Handbook of Energy Crops, unpublished
⁵Özcan M & Seven S. 2003. Physical and chemical analysis and fatty acid composition of peanut, peanut oil and peanut butter from COM and NC-7 cultivars. Grasas y Aceites, 54: 12-18.
⁶Cosge B et al. 2007. Oil content and fatty acid composition of some (Carthamus tinctorius L.) varieties sown in spring and winter. International Journal of Natural Engineering and Science, 1: 11-15
⁷Chowdhury RA et al. 2007. Studies on the fatty acid composition of edible oil. Bangladesh Journal of Science and Industrial Research, 42(3): 311-316.
⁸Przybylski R. 2013. Canola Oil. Physical and Chemical Properties. www.canolacouncil.org/media/515239
⁹Liu R et al. 2013. Rapid analysis of fatty acid profiles in raw nuts and seeds by microwave ultrasonic synergistic in situ extraction-derivatisation and gas chromatography by mass-spectrometry. Food Chemistry, 141: 4269-4277,

TABLE 6
Ranges and averages of relevant fatty acids of some ingredients in commercial seed mixes.

| | | | 16:0 | 18:0 | 18:1 | 18:2 | 18:3 |
|---|---|---|---|---|---|---|---|
| | | | (palmitic | (stearic | (oleic | (linoleic | (linolenic |
| | Protein | Fat | acid) | acid) | acid) | acid) | acid) |
| Almonds, | 24.1% | 48.3% | 5.07- | 1.3%⁶ | 57.54- | 19.32- | 0.04- |
| raw | | | 6.78%^{3, 6} | | 73.94%^{3, 6} | 35.18%^{3, 6} | 0.1%³ |
| Juniper | 19.8% | 14.6% | n/a | n/a | n/a | n/a | n/a |
| Berries¹ | | | | | | | |
| Pecans | 10.0% | 67.5% | 5.1%⁴ | 1.9%⁴ | 54.2%⁴ | 32.2%⁴ | 2.2%⁴ |
| | | | 5.7%⁶ | 2.5%⁶ | 65.4%⁶ | 25.0%⁶ | 1.4%⁶ |
| Pine nuts | 14.0% | 68.0% | 6.2%⁶ | 2.8%⁶ | 32.8%⁶ | 55.2%⁶ | — |
| | | | 6.5- | 4.0- | 30.6- | | |
| | | | 8.9%⁸ | 6.3%⁸ | 43.7%⁸ | | |
| Pumpkin | 25.4% | 41.6% | 10.7%⁵ | 8.7%⁵ | 38.4%⁵ | 39.8⁵ | 0.68⁵ |
| Sesame, | | | 13.8%⁷ | 5.9- | 37.1- | 37.5- | 0.38%⁹ |
| white | | | | 6.6%%⁷ | 38.1%⁷ | 40.0%⁷ | |
| Walnuts | 15.2% | 57.6% | 3.4%⁶ | 3.0%⁶ | 29.0%⁶ | 61.2%⁶ | 3.4%⁶ |
| | | | 6.1%⁷ | 2.4- | 25.7- | 49.3- | 12.5- |
| | | | | 3.2%⁷ | 26.8%⁷ | 50.0%⁷ | 13.4%⁷ |
| Blueberries | 2.5% | 2.5% | — | — | — | — | — |
| Cherries | 3.3% | 0.1% | — | — | — | — | — |
| Papaya | 11.3% | 1.0% | 0.03%² | — | 0.02%² | — | 0.03%² |
| Raisins | 2.5% | 9.6% | — | — | — | — | — |

¹http://www.queenswoodfoods.co.uk/specs/HE590.pdf
²http://www.producespec.com/cgi-bin/index.pl/menu_id=107
³Sathe SK et al. 2008. Fatty acid composition of California grown almonds. Journal of Food Science, 73(9): C607-614.
⁴http://georgiapecancompany.com/pecan-nutritional-value/
⁵Ardabili AG, Farhoosh R & Khodaparast MHH. 2011. Chemical composition and physiochemical properties of pumpkin seeds (Cucurbita pepo Subsp. Pepo var. Styriaka) grown in Iran. Journal of Agriculture and Science Technology, 13: 1053-1063.
⁶Kim JK et al. 2013. Composition of fatty acids in commercially available tree nuts and their relationship with protective effects against oxidative stress-induced neurotoxicity. Food Science and Biotechnology, 22(4): 1097-1104.
⁷Liu R et al. 2013. Rapid analysis of fatty acid profiles in raw nuts and seeds by microwave ultrasonic synergistic in situ extraction-derivatisation and gas chromatography by mass-spectrometry. Food Chemistry, 141: 4269-4277,
⁸Nasir N et al. 2005. Fatty acids from seeds of Pinus pinea L. : composition and population profiling. Phytochemistry, 66: 1729-1735.
⁹Cordain L. 2013. www.thepaleodiet.com/seed-fatty-acid-composition/
Note:
the symbol “—“ means negligible to none; n/a: not available

Unsaturated dietary fats are important for migrating, wintering and breeding birds because they can preferentially mobilize unsaturated fatty acids from fat cells for rapid oxidation by bird flight muscles. Birds with diets higher in unsaturated fats also use less energy (see McWilliams S R & Pierce B J. 2005. Seasonal changes in composition of lipid stores in migratory birds: causes and consequences. The Condor, 107: 269-279.).

The composition of body fat stores in wild birds is 75% unsaturated fats taken directly from the diet and includes 16:1 (palmitoleic acid; metabolized from 16:0, palmitic acid), 18:1 (oleic acid) and 18:2 (linoleic acid) with a small percentage of saturated fats as the fatty acid 18:0 (stearic acid) (see McWilliams S R et al. 2004. Flying, fasting and feeding in birds during migration: a nutritional and physiological ecology perspective. Journal of Avian Biology, 35: 377-393.). For example, the fat deposits of birds were found to consist of three fatty acids that were 90% of dietary fatty acids (see McWilliams S R & Pierce B J. 2005. Seasonal changes in composition of lipid stores in migratory birds: causes and consequences. The Condor, 107: 269-279.). There is also some selective metabolism and 10% of fatty acids in depot fat are transformed from dietary fatty acids by selective metabolism (see Guglielmo C G. 2010. Move that fatty acid: fuel selection and transport in migratory birds and bats. Integrative and Comparative Biology, 50(3): 336-345.).

The ranges and averages of fatty acids found in the depot fats of various bird species during migration (fall and winter) and breeding are shown in Table 7. Since the body fat stores of birds are largely composed of fatty acids obtained directly from the diet, feed mixes can be formulated to provide an approximate measure of the fatty acids needed to support normal fat stores. The approximate measure is appropriate because we expect wild bird species to ingest food other than that provided in feeders.

TABLE 7
Ranges and averages of fatty acids in fat deposits of various bird
species during migration (fall and spring), winter and breeding (spring
migration)

| | 16:0 | | | | 18:3 |
|---|---|---|---|---|---|
| Seed/Nut | (palmitic | 18:0 (stearic | 18:1 (oleic | 18:2 (linoleic | (linolenic |
| (hulled) | acid) | acid) | acid) | acid) | acid) |
| Breeding | 29.8%^{1,5} | 6.9%^{1,5} | 39.7%^{1,5} | 14.4%^{1,5} | 4.2%¹ |
| (Spring | 4.6%³ | 1.7%³ | 9.4%³ | 81.2%³ | 2.2%³ |
| migration) | 24.0%⁷ | 13.8%⁷ | 34.4%⁷ | 12.0%⁷ | 3.9%⁷ |
| Range: | 4.6-29.8% | 1.7-13.8% | 9.4-39.7% | 12.0-81.2% | 2.2-4.2% |
| Migration | 17.5%^{1,5} | 2.5%^{1,5} | 32.8%^{1,5} | 24.9%¹ | 16.1%¹ |
| (Fall and | 1.0-7.5%² | 2.5-17.7%² | 11.0-53.2%² | 1.8-38.6%² | 1.1-16.6%² |
| Winter) | 11.4-11.7%^{3,4} | 5.8%³ | 16.9%³ | 48.4%³ | 2.2%³ |
| | 11.0-17.5%⁶ | 16.0%⁴ | 17.0-19.0%⁶ | 16.1%⁵ | 1.3%⁷ |
| | 15.2%⁷ | 21.0-26.0%⁶ | 61.6%⁷ | 6.0-23.0%⁶ | |
| | | 7.6%⁷ | | 7.6%⁷ | |
| Range: | 1.0-17.5% | 2.5-26.0% | 11.0-61.6% | 1.8-48.4% | 1.1-16.6% |

¹Pierce BJ & McWilliams SR. 2005. Seasonal changes in composition of lipid stores in migratory birds: causes and consequences. The Condor, 107(2): 269-279.
²Blem CR. 1976. Patterns of lipid storage and utilization in birds. American Zoologist, 16: 671-684.
³West GC & Meng MS. 1968. The effect of diet and captivity on the fatty acid composition of red poll (Acanthis flammea) depot fats. Comparative Biochemistry and Physiology, 25: 535-540.
⁴Palokangas R & Vikko V. 1972. Fatty acids in the subcutaneous depot fat tissue of the titmouse (Parus major L.) in winter and summer. Comparative Biochemistry and Physiology, 41B: 925-929.
⁵McWilliams SR & Pierce BJ. 2005. Seasonal changes in composition of lipid stores in migratory birds: causes and consequences. The Condor, 107: 269-279.
⁶McWilliams SR et al. 2004. Flying, fasting and feeding in birds during migration: a nutritional and physiological ecology perspective. Journal of Avian Biology, 35: 377-393.
⁷Conway CJ, Eddleman WE & Simpson KL. 1994. Seasonal changes in fatty acid composition of the wood thrush. The Condor, 96: 791-794.

As omnivores, most seed-eating, wild bird species will also eat fruit when available. However, wild fruit is high in protein and fat, unlike domesticated fruit species (see Table 6, above). Unfortunately, in most cases, only domesticated fruit is available for seed mixes and adding to a seed mix would dilute the overall protein and fat level. Most dried fruits are also processed using sugars and oils that may not be appropriate to feed to birds.

Fruit is also a source of carotenes and dietary carotenes support immune function and integument colour in bird species, even in those species without bright colours (see McGraw K J et al. 2001. The influence of carotenoid acquisition and utilization on the maintenance of species-typical plumage pigmentation in male American goldfinches (Carduelis tristis) and northern cardinals (Cardinalis cardinalis). Physiological and Biological Zoology, 74(6): 843-852; see also McGraw K J, Nolan P M & Crino O L. 2011. Carotenoids bolster immunity during moult in a wild song bird with sexually selected plumage coloration. Biological Journal of the Linnean Society, 102(3): 560-572; see also Metzger B J & Bairlein F. 2011. Fat stores in a migratory bird: a reservoir of carotenoid pigments for times of need? Journal of Comparative Physiology B, 181: 269-275). Seed-eating wild bird species can obtain carotenes from seeds and nuts, but the inclusion of colourful fruit would provide a wider spectrum of carotenes.

Seeds provide carotenoids in the form of two xanophylls: lutein and zeaxanthin (see Blair R & March B E. 1989. Research note: canola as a source of xanthophyll for poultry diets. Poultry Science, 68(12): 1718-1719; see also Howitt C A & Pogson B J. 2006. Carotenoid accumulation and function in seeds and non-green tissues. Plant, Cell & Environment, 29: 435-445) that are found in abundance in the wild diets and in the plasma and body fat of wild birds (see Metzger B J & Bairlein F. 2011. Fat stores in a migratory bird: a reservoir of carotenoid pigments for times of need? Journal of Comparative Physiology B, 181: 269-275). Ninety-five percent (95%) of the carotenoids in the plasma of avian species are lutein and zeaxanthin and these are usually found together in the same foods (see McGraw K J et al. 2003. Lutein-based plumage coloration in songbirds is a consequence of selective pigment incorporation into feathers. Comparative Biochemistry and Physiology, Part B, 135: 689-696), although lutein is usually found in higher ratios than zeaxanthin (see McGraw K J et al. 2004. Differential accumulation of dietary carotenoids in finches. Physiological and Biochemical Zoology, 77(3): 484-491; see also Cohen A A, McGraw K J & Robinson W D. 2009. Serum antioxidant levels in wild birds vary in relation to diet, season, life history strategy, and species. Oecologia, 161: 673-683).

Ingredients within the bird seed industry considered to be fillers are milo, millet, cereal grains (corn, oats, wheat, etc.). In general, cheaper mixes will be comprised of these ingredients exclusively, or will have high levels of these ingredients. These are the ingredients most commonly left by wild birds, or are eaten only when more palatable feed is not available. Compared to wild feeding ecology, the ingredients considered fillers are also lower fat foods and would not provide the amount of fatty acids and the spectrum needed to support migration, winter survival and breeding.

Table 8 and Table 9 describe averages and ranges of protein, fat and fatty acids found in some seeds and grains. For wild bird species, these are foods they are most likely to eat in late spring and summer when they are preferentially feeding on insects that would provide high protein and fat (fatty acids).

TABLE 8
Average protein and fat content of low-fat seeds and grains used
in seed mixes.

| Ingredient | Protein (%) | Fat (%) |
|---|---|---|
| Barley | 11.0 | 2.0 |
| Canary seed | 16.6 | 5.9 |
| Cracked corn | 9.0 | 4.3 |
| Millet | 11.0 | 4.2 |
| Oat Groats | 15.9-20.0 | 6.8-8.8 |
| Rice (white, brown, | 10.0 | 0.2-0.5 |
| pieces) | | |
| Sorghum (milo) | 10.8 | 3.4 |
| Steamed Rolled | 12.1 | 5.1 |
| Oats | | |
| Wheat | 16.5 | 2.0 |

TABLE 9
Averages and ranges of some fatty acids of some seed and grains.

| | | | | | 18:3 |
|---|---|---|---|---|---|
| | 16:0 (palmitic | 18:0 (stearic | 18:1 (oleic | 18:2 (linoleic | (linolenic |
| Grain or Seed | acid) | acid) | acid) | acid) | acid) |
| Barley, grain | 18.0-23.79%^{6,7} | 0.28-4.58%^{6,7} | 14.6-22.4%⁶ | 39.5-53.4%⁶ | 4.7-25.1%⁶ |
| | | | 12.2-18.3%⁷ | 53.1-59.4%⁷ | 4.1-4.8%⁷ |
| Canary seed | 12.0%¹ | 1.29%¹ | 30.93%¹ | 51.1%¹ | 2.2%¹ |
| Millet, pearl | 16.7-25.0%^{4,5} | 1.8-8.0%^{4,5,12} | 20.2-30.6%^{4,5} | 40.3-51.7%^{4,5} | 2.3-5.8%^{4,5,12} |
| Seed | 7.2-9.9%¹² | | 11.1-16.7%¹² | 64.9-72.2%¹² | |
| Oats | 19.6%^{9,11} | 1.4%⁹ | 38.7%⁹ | 38.9%⁹ | 1.5%^{9,11} |
| | | 1.3-1.6%¹¹ | 32.4-36.5%¹¹ | 40.3-42.3%¹¹ | |
| Oat groats, | 16.1%⁸ | 1.2-2.0%⁸ | 28.4-42.3%⁸ | 36.6-45.8%^{8,9} | 1.5-2.5%^{8,9} |
| grain | | | | | |
| Rice, white or | 0.66-3.9%¹⁰ | 0.04-0.38%¹⁰ | 1.0-9.5%¹⁰ | 1.7-9.3%¹⁰ | 0.08-0.31%¹⁰ |
| brown | | 1.9-2.0%¹¹ | | | 0.9-1.4%¹¹ |
| Sorghum, grain | 14.3%⁵ | 2.1%⁵ | 31.0%⁵ | 49.0%⁵ | 2.7%⁵ |
| | 15.4-17.9%^{6,11} | 1.5-3.3%^{6,11} | 29.2-38.0%^{6,11} | 38.3-45.7%⁶ | 1.04-2.1%⁶ |
| | | | | 36.7-40.1%¹¹ | 0.9-2.3%¹¹ |
| Wheat, grain | 16.7-19.3%^{2,3} | 0.5-0.9%2, 1.0%³ | 10.7-11.6%² | 62.5-64.6%^{2,3} | 5.0-7.1%^{2,3} |
| | | | 13.9%³ | | |

¹Canary Seed Development Commission of Saskatchewan, 2011
²Escarnot E et al. 2012. Comparative study of the content and profiles of macronutrients in spelt and wheat, a review. Biotechnology, Agronomy, Society and Environment Journal, 16(2): 243-256.
³Burkwall Jr MP & Glass RL. 1965. The fatty acid of wheat and its milled products. Cereal Chemistry, 42: 236-246.
⁴Jellum MD & Powell JB. 1971. Fatty acid composition of oil from pearl millet seed. Agronomy Journal, 63(3): 29-33.
⁵Rooney LW. 1978. Sorghum and pearl millet lipids. Cereal Chemistry, 55(5): 584-590.
⁶Osman RO et al. 2000. Oil content and fatty acid composition of some varieties of barley and sorghum grains. Grasas y Aceites, 51(3): 157-162.
⁷Bhatty RS & Rossnagel BG. 1980. Lipids and fatty acid composition of Riso 1508 and normal barley. Cereal Chemistry, 57(6): 382-386.
⁸Zhou M et al. 1999. Oat lipids. Journal of the American Oil Chemists Society, 76(2): 159-169.
⁹Youngs VL. 1978. Oat lipids. Cereal Chemistry, 55(5): 591-597.
¹⁰Zhou M et al. 2002. Fatty acid composition of three rice varieties following storage. Journal of Cereal Science, 37(3): 327-335.
¹¹Liu K. 2011. Comparison of lipid content and fatty acid composition and their distribution within seeds of small grain species. Journal of Food Science, 76(2): C334-C342.
¹²Taira H. 1984. Lipid content and fatty acid composition of nonglutinous and glutinous varieties of foxtail millet. Journal of Agriculture and Food Chemistry, 32: 369-371.

Although the levels of fatty acids may appear similar to high fat seeds and nuts, these percentages are based on the low fat level. For example, canary seed is reported to have 12.0% palmitic acid (16:0). However, this is 12% relevant to the average 5.9% fat level of canary seed. Compare this to niger (nyger) seed which has 17% palmitic acid (16:0), but this is 17% relevant to the average fat level of 35.4% resulting in a much higher level of palmitic acid in niger (nyger) as compared to canary seed.

In view of the foregoing, formulations of wild bird feed can be prepared that are tailored for particular sizes of birds (i.e., small, medium or large), and provide appropriate nutritional content. In particular, it is apparent that the wild feeding ecology of birds for fall and spring migrations, winter survival and breeding is preferential feeding on high fat foods selective for foods high in unsaturated fatty acids, especially 16:1 (palmitoleic acid; metabolized from 16:0, palmitic acid) and the C18 fatty acids (oleic (18:0), linoleic (18:2), linolenic (18:3)). Seventy-five percent (75%) to 90% of the body fat stores of seed-eating wild bird species are composed 16:1 (palmitoleic acid; also metabolized from 16:0, palmitic acid), 18:1 (oleic acid) and 18:2 (linoleic acid) with a small percentage of saturated fats in the form of 18:0 (stearic acid) (see McWilliams S R et al. 2004. Flying, fasting and feeding in birds during migration: a nutritional and physiological ecology perspective. Journal of Avian Biology, 35: 377-393). Dietary fatty acids in wild bird diets can be directly assimilated into body fat stores.

Using the foregoing information, seed mixes can be designed using preferred seeds to supplement the diets of wild birds and provide similar levels of protein and fat they would select in the wild with the appropriate range of fatty acids to support migration (winter and spring), winter survival and breeding. This approach is unique to existing wild bird feed products.

The inventors have composed nine formulas designed to approximate wild feeding ecology by species size. The nine formulations are provided below. Examples of bird species by size are provided with each formulation.

Finch: 100% Niger (nyger) Seed: For finch species in feeders designed for the small size of the seed (2 to 3 mm or 0.08-0.11 inches).

Finch: Small Seed Mix: This is a mix of 50% niger (nyger) and 50% sesame seed that can be used in finch feeders because sesame seeds are similar in size to niger (nyger).

Small Bird Mix: This mix is designed for bird species weighing less than 60 g such as bobolink, bunting, cowbird, chickadee, crossbill, downy woodpecker, finch, grey catbird, junco, longspurs, nuthatches, pine siskin, pipit and, redpoll. The mix is composed of equal parts (20%) of niger (nyger), black oil sunflower (or sunflower chips), peanut pieces, sesame (or flax) and safflower pieces.

An alternative to the Small Bird Mix, in which the black oil sunflower or sunflower chips are replaced with full fat canola seed, is possible. Another alternative, in which the black oil sunflower or sunflower chips are replaced with Canary grass seed, instead of full fat canola seed, is also possible.

Premium Small Bird Mix: This mix is designed for bird species weighing less than 60 g such as bobolink, bunting, cowbird, chickadee, crossbill, downy woodpecker, finch, grey catbird, junco, longspurs, nuthatches, pine siskin, pipit and, redpoll. This mix is composed of 25% black oil sunflower, 25% peanut pieces, 20% hulled, sunflower pieces, 20% pine nuts and 10% juniper berries.

Medium-sized Bird Mix: This mix is designed for seed-eating species weighing more than 50 g but less than 100 g such as blackbirds (Brewer's, red-winged and rusty), cardinal, dickcissel, grosbeak and, some woodpecker species (black-backed, hairy, red-headed). This mix is composed of equal parts (25%) black oil sunflower, whole hulled sunflower, peanut pieces and safflower.

Alternatives to the Medium-sized Bird Mix are possible, in which the whole, hulled sunflower is replaced with one of Canary grass seed, flax seed or in-shell striped sunflower seeds.

Premium Medium-sized Bird Mix: This mix is designed for seed-eating species weighing more than 50 g but less than 100 g such as blackbirds (Brewer's, red-winged and rusty), cardinal, dickcissel, grosbeak and, some woodpecker species (black-backed, hairy, red-headed). It is composed of 25% black oil sunflower, 25% whole hulled sunflower, 20% safflower, 20% pine nuts and 10% juniper berries.

An alternative to the Premium Medium-sized Bird Mix, in which whole hulled sunflower is replaced with in-shell, striped sunflower seeds, is possible. As well, the following alternatives are also possible:
a. a mix comprising 27.5% black oil sunflower, 40% in-shell, striped sunflower seeds, 30% peanuts (either shelled or in pieces), and 2.5% pine nuts;
b. a mix comprising 27.5% black oil sunflower, 40% in-shell, striped sunflower seeds, 30% peanuts (either shelled or in pieces), and 2.5% juniper berries; and
c. a mix comprising 30% black oil sunflower, 40% in-shell, striped sunflower seeds, and 30% peanuts (either shelled or in pieces).

Large Bird Mix: This mix is for larger, seed-eating bird species weighing more than 100 g such as black-billed magpie, common grackle, jays (blue, grey and Stellar), northern flicker and the pileated woodpecker. It is composed of equal parts (50%) whole hulled sunflower and shelled peanuts.

As an alternative to the Large Bird Mix, the hulled sunflower seeds can be replaced with in-shell, striped sunflower seeds.

Large Bird Mix with Safflower: This mix is for larger, seed-eating bird species weighing more than 100 g such as black-billed magpie, common grackle, jays (blue, grey and Stellar), northern flicker and the pileated woodpecker. It is composed of equal parts (40%) whole, hulled sunflower and whole, shelled peanuts with 20% safflower.

As an alternative to the Large Bird Mix with Safflower, the hulled sunflower seeds can be replaced with in-shell, striped sunflower seeds.

Premium Large Bird Mix: This mix is for larger, seed-eating bird species weighing more than 100 g such as black-billed magpie, common grackle, jays (blue, grey and Stellar), northern flicker and the pileated woodpecker. It is composed of 35% shelled peanuts, 25% whole, hulled sunflower, 20% pine nut, 10% safflower and 10% juniper berry.

Table 10 describes the average and ranges of the protein, fat and fatty acids of each formula relevant to depot fat stores in migrating (winter and spring), wintering and breeding wild birds (approximate goal).

TABLE 10
Average and ranges of protein, fat and some fatty acids in nine formulas
as compared to depot fat ranges from wild birds (approximate goal).

| | | | 16:0 | 18:0 | 18:1 | 18:2 | 18:3 |
|---|---|---|---|---|---|---|---|
| | | | (palmitic | (stearic | (oleic | (linoleic | (linolenic |
| Formula | Protein | Fat | acid) | acid) | acid) | acid) | acid) |
| Approximate | 15.2- | 15.5- | 1.0- | 1.7- | 9.4- | 1.8- | 1.1- |
| Goal | 23.7% | 28.7% | 29.8% | 26.0% | 61.6% | 81.2% | 16.6% |
| (relevant to | | | | | | | |
| depot fat data) | | | | | | | |
| Finch: 100% | 22.3% | 35.4% | 5.0- | 2.0- | 11.0- | 51.6- | 3.0% |
| Niger (nyger) | | | 17.0% | 7.0% | 38.9% | 54.3% | |
| seed | | | | | | | |
| Finch: Small | 21.4% | 42.7- | 9.4- | 4.9- | 40.2- | 31.4- | 1.7% |
| Seed Mix | | 47.7% | 15.4% | 6.5% | 46.6% | 37.6% | |
| Small Bird | 20.3% | 45.3% | 7.7- | 3.3- | 30.6- | 28.1- | 0.32- |
| Mix | | | 11.8% | 6.1% | 45.1% | 45.7% | 0.46% |
| | | | | | | | without flax |
| | | | | | | | 9.1- |
| | | | | | | | 9.3% |
| | | | | | | | with flax |
| Alternative | 20.7- | 43.7- | Approx. | Approx. | 36.6- | 20.1- | 2.32- |
| using Canola | 21.1% | 44.8% | same | same | 51.1% | 37.7% | 2.46% |
| seed | | | | | | | without flax |
| | | | | | | | 11.1- |
| | | | | | | | 11.3% |
| | | | | | | | with flax |
| Alternative | Approx. | 36.9% | 8.7- | 2.7- | 24.8- | 26.8- | 0.74- |
| using Canary | same | | 12.8 | 5.5% | 39.4% | 44.4% | 0.88% |
| grass seed | | | | | | | without flax |
| | | | | | | | 9.5- |
| | | | | | | | 9.7% |
| | | | | | | | with flax |
| Premium | 18.8% | 49.0% | 6.3- | 2.5- | 25.9- | 38.0- | 0.1- |
| Small | | | 8.3%+ | 5.9%+ | 43.0%+ | 48.8%+ | 0.13%+ |
| Bird Mix* | | | | | | | |
| Medium-sized | 19.0% | 45.9% | 6.4- | 2.3- | 23.3- | 31.3- | 0.11- |
| Bird Mix | | | 8.9% | 6.2% | 44.6% | 53.8% | 0.14% |
| Alternative | Approx. | 34.5% | Approx. | 1.5- | 16.1- | 29.6- | 0.6% |
| using Canary | same | | same | 5.4% | 37.4% | 52.1% | |
| grass seed | | | | | | | |
| Alternative | 20.0% | 43.8% | Approx. | 2.1- | 22.0- | 20.9- | 12.1% |
| using flax seed | | | same | 6.0% | 43.3% | 43.4% | |
| Alternative | 17.4% | 41.1% | 5.7- | 1.9- | 20.3- | 25.6- | 0.1- |
| using striped | | | 8.2% | 5.8% | 41.6% | 48.0% | 0.13% |
| sunflower | | | | | | | |
| Premium | 16.4%+ | 46.1%+ | 5.2- | 1.8- | 18.1- | 35.4- | 0.08- |
| Medium-sized | | | 7.0%+ | 5.6%+ | 37.9%+ | 54.0%+ | 0.3%+ |
| Bird Mix* | | | | | | | |
| Alternative | 14.7% | 22.4% | 4.7- | 1.3- | 20.1- | 12.0- | 0.2- |
| using striped | | | 7.1% | 4.9% | 38.3% | 26.2% | 0.6% |
| sunflower | | | | | | | |
| Alternative | 29.6% | 49.2% | 10.5- | 4.0- | 42.8- | 34.8- | 0.2- |
| using peanuts | | | 12.9% | 7.6% | 61.0% | 49.0% | 0.3% |
| and pine nuts | | | | | | | |
| Alternative | 29.8% | 50.5% | 10.5- | 4.0- | 42.8- | 34.8- | 0.2- |
| using peanuts | | | 12.9% | 7.6% | 61.0% | 49.0% | 0.3% |
| and juniper | | | | | | | |
| berries | | | | | | | |
| Alternative | 29.7% | 49.8% | 10.6- | 4.1- | 43.2- | 35.7- | 0.2- |
| using peanuts | | | 13.0% | 7.7% | 61.4% | 49.9% | 0.3% |
| Large Bird | 21.3% | 43.9% | 7.7- | 2.9- | 32.1- | 35.6- | 0.16- |
| Mix: | | | 10.1% | 6.5% | 50.3% | 49.8% | 0.21% |
| Alternative | 18.0% | 24.7% | 6.3- | 2.0- | 26.2- | 24.1- | 0.14- |
| using striped | | | 8.7% | 5.6% | 44.4% | 38.3% | 0.19% |
| sunflower | | | | | | | |
| Large Bird | 20.2% | 42.9% | 6.9- | 2.5- | 27.7- | 29.9- | 0.15- |
| Mix with | | | 9.7% | 6.1% | 46.7% | 50.7% | 0.36% |
| Safflower | | | | | | | |
| Alternative | 16.9% | 33.3% | 5.5- | 1.6- | 21.8- | 18.3- | 0.1- |
| using striped | | | 8.3% | 5.3% | 40.8% | 39.1% | 0.34% |
| sunflower | | | | | | | |
| Premium | 21.0%+ | 50.8+% | 6.3- | 2.5- | 27.2- | 32.0- | 0.11- |
| Large Bird | | | 9.0%+ | 5.8%+ | 42.6%+ | 44.8%+ | 0.22+ |
| Mix* | | | | | | | |

*The fatty acids in these mixes will be higher because the fatty acids associated with juniper berries are not included. Data on the fatty acid spectrum of juniper berries is not available.

It should be noted that, in formulas 3 to 9, the linolenic content is below the approximate goal percentage as indicated by depot fat. This could be increased by adding walnuts or flax to the formula (both are very high in linolenic acid). Walnuts, however, would greatly increase the price of the feed. As well, flax is reported to be eaten only by small bird species, especially if it is included in a mix of equally small seeds. However, since the formulas are supplementary feeding for birds that will also be foraging in the wild, the intent is not to provide a complete diet. Therefore raising the level of linolenic acid may not be necessary.

It will be apparent to those of skill in the art that numerous alternative formulations of wild bird feed, other than the example embodiments described above, are possible. All such readily apparent alternatives are intended to be within the scope of the present invention. The scope of the present invention is not intended to be limited to the example embodiments described above, but is defined by the following claims, which are to be given the broadest possible interpretation consistent with the specification as a whole.

1. A feed mix for birds, comprising at least one of seeds, nuts and berries, the mix having:
an aggregate protein content in the range of 14% to 30% by dry weight;
an aggregate fat content in the range of 15% to 51% by dry weight;
an aggregate content of palmitic acid in the range of 1% to 30% by dry weight;
an aggregate content of stearic acid in the range of 1.0% to 26% by dry weight;
an aggregate content of oleic acid in the range of 9% to 62% by dry weight;
an aggregate content of linoleic acid in the range of 1.5%-81.5% by dry weight; and
an aggregate content of linolenic acid in the range of 0.05% to 17% by dry weight.

2. The feed mix of claim 1, wherein the seeds, nuts or berries comprising the mix are selected from those having a size that is appropriate for birds having a mass less than 60 grams.

3. The feed mix of claim 2, wherein the mix is comprised of one or more of nyger seeds, sesame seeds, black oil sunflower seeds, black oil sunflower chips, peanut pieces, flax and safflower pieces.

4. The feed mix of claim 1, wherein the seeds, nuts or berries comprising the mix are selected from those having a size that is appropriate for birds having a mass in the range of 50 grams to 100 grams.

5. The feed mix of claim 4, wherein the mix is comprised of one or more of black oil sunflower seeds, whole hulled sunflower seeds, peanut pieces, safflower, pine nuts and juniper berries.

6. The feed mix of claim 1, wherein the seeds, nuts or berries comprising the mix are selected from those having a size that is appropriate for birds having a mass greater than 100 grams.

7. The feed mix of claim 6, wherein the mix is comprised of one or more of whole hulled sunflower seeds, shelled peanuts, safflower, pine nuts and juniper berries.

8. The feed mix of claim 1, wherein the feed mix comprises substantially 100% nyger seed.

9. The feed mix of claim 1, wherein the feed mix comprises substantially 50% nyger seed and substantially 50% sesame seed.

10. The feed mix of claim 1, wherein the feed mix comprises substantially equal parts nyger seed, one of black oil sunflower seeds or sunflower chips, peanut pieces, one of sesame seed or flax, and safflower pieces.

11. The feed mix of claim 1, wherein the feed mix comprises substantially equal parts nyger seed, one of canola seed or canary grass seed, peanut pieces, one of sesame seed or flax, and safflower pieces.

12. (canceled)

13. (canceled)

14. The feed mix of claim 1, wherein the feed mix comprises substantially 25% black oil sunflower seeds, one of substantially 25% peanut pieces or hulled sunflower seeds, substantially 20% hulled sunflower pieces, substantially 20% pine nuts and substantially 10% juniper berries.

15. The feed mix of claim 1, wherein the feed mix comprises substantially equal parts of black oil sunflower seeds, one of canary grass seed or whole hulled sunflower seeds, peanut pieces and safflower.

16. (canceled)

17. The feed mix of claim 1, wherein the feed mix comprises substantially equal parts of black oil sunflower seeds, one of striped sunflower seeds in shells or flax seed, peanut pieces and safflower.

18. (canceled)

19. (canceled)

20. The feed mix of claim 1, wherein the feed mix comprises substantially 40% black oil sunflower seeds, substantially 25% striped sunflower seeds in shells, substantially 30% safflower, substantially 2.5% pine nuts and substantially 2.5% juniper berries.

21. The feed mix of claim 1, wherein the feed mix comprises substantially 27.5% black oil sunflower seeds, substantially 40% striped sunflower seeds in shells, substantially 30% peanuts, and substantially 2.5% pine nuts.

22. (canceled)

23. (canceled)

24. The feed mix of claim 11, wherein the feed mix comprises substantially 27.5% black oil sunflower seeds, substantially 40% striped sunflower seeds in shells, substantially 30% peanuts, and substantially 2.5% juniper berries.

25. (canceled)

26. (canceled)

27. (canceled)

28. (canceled)

29. (canceled)

30. The feed mix of claim 1, wherein the feed mix comprises substantially equal parts of sunflower seeds and peanuts.

31. (canceled)

32. The feed mix of claim 1, wherein the feed mix comprises substantially 40% whole, sunflower seed, substantially 40% whole, shelled peanuts and substantially 20% safflower.

33. (canceled)

34. The feed mix of claim 1, wherein the feed mix comprises substantially 35% shelled peanuts, substantially 25% whole, hulled sunflower, substantially 20% pine nuts, substantially 10% safflower and substantially 10% juniper berry.

35. (canceled)

36. (canceled)

37. (canceled)
